(19) United States
(12) Patent Application Publication
(10) Pub. No.: US 2005/0216474 A1
(43) Pub. Date: Sep. 29, 2005

(54) Retrieving dynamically-generated and database-driven web pages using a search engine robot

(76) Inventor: Jason Wiener, Chicago, IL (US)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 10/982,687

(22) Filed: Nov. 5, 2004

Related U.S. Application Data
(60) Provisional application No. 60/517,634, filed on Nov. 5, 2003.

(51) Int. Cl. G06F 7/00

(52) U.S. Cl. 707/10

(57) ABSTRACT

The present invention in one embodiment includes a computer implemented method for performing a crawl of a web-site that contains linked web pages. The invention includes retrieving a URL with variable that identifies said web page and utilizing said variable to gain access to said web page.

### CROSS REFERENCE TO RELATED APPLICATIONS

The present application claims benefit to provisional application 60/517,634 filed Nov. 5, 2003.

### BACKGROUND OF THE INVENTION

1. Field of the Invention

The present invention relates generally to the retrieval of web pages. More particularly the invention relates to web pages that are customized and delivered to users based on a user's request and/or that are generated using information stored in a database.

2. Description of Related Art

The World Wide Web (“web”) contains a vast amount of information not currently accessible by search engines due to the fact that search engine robots, (also referred to as bots, crawlers or spiders) are not compatible with pages that utilize dynamic variables. Web servers use unique URL addresses that instruct page templates on how and what custom content they should display in response to a user's request. A web “crawl” consists of retrieving pages from a targeted web server, cataloging hyperlink references from each page retrieved and adding those hyperlinks to a queue for future retrieval. Once the queue has been exhausted, the crawl has been completed. However, because of the possibilities and potential permutations of variables and values for a particular dynamic web page may bots are incapable of accessing, cataloging and reposing a target web site's dynamic documents for use in current search engine indexes.

### SUMMARY OF THE INVENTION

The purpose of the invention is to enable a search engine bot to build a collection of web pages from a particular web site utilizing dynamically generated pages, which may utilize database-stored information. Web servers publish content via dynamically-generated web pages by specifying customization variables sent via the URL request (called the querystring). Databases are also commonly used to more efficiently propagate content without the need to store individual documents with each piece of unique content available on a web site. Documents are customized based on user requests and typically have a finite number of permutations associated with each document (also known as a page template). The method of the invention identifies the dynamic variables being used from web pages on a particular web site and then retrieves the page template populated with all possible content permutations available. In addition the method of the invention may also save the variables and values to a database for further use.

### BRIEF DESCRIPTION OF THE DRAWINGS

The accompanying drawings, incorporated in and constitute part of this specification, illustrate an embodiment of the invention and, together with the description, explain the invention. In the drawings,

FIG. 1 is a diagram illustrating an exemplary system in which concepts consistent with the present invention may be implemented;

FIG. 2 is a flow chart illustrating an exemplary system in which the invention may function in conjunction with a search engine crawler application;

FIG. 3 is a flow chart illustrating methods consistent with the present invention for identifying, cataloging and storing dynamically-generated web pages from a target web site; and

FIG. 4 is a flow chart illustrating, in additional detail, methods consistent with the present invention for identifying and cataloging dynamic page generation information for a target web site.

### DETAILED DESCRIPTION

Overview

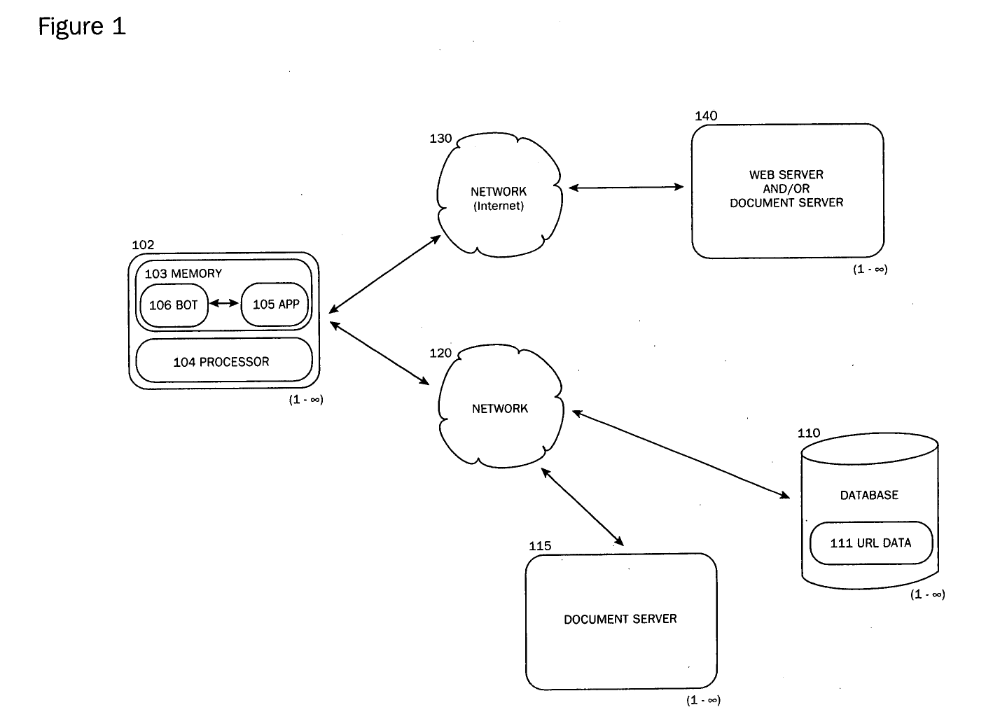

A generalized computer network diagram, consistent with the present invention is illustrated in FIG. 1. The invention consists of an application 105, written in a computer-readable language, executed in memory 103 on any number of computers or servers 102 that are used in conjunction with search engine crawling practices. Computers 102 may be logically connected to a private local area network 120 containing any number of document servers 115 and/or database servers 110. The computers 102 are also logically connected to a network 130 (such as the Internet) containing any number of document servers 140. FIG. 1 illustrates the invention as being executed in memory 103 in conjunction with the computer 102 running the search engine bot 106. The computer 102 may or may not run the search engine bot application 106 locally. In cases where the bot 106 is not executed locally, the invention application 105 can be accessed over the network 120. Within the database servers 110, details about the web page variables used by the target web site are stored 111. These variables 111 may be stored in database applications including (but not limited to) MySQL, Oracle, Microsoft SQL Server or Filemaker Pro or as documents formatted as (but not limited to) text, XML or HTML.

Operation

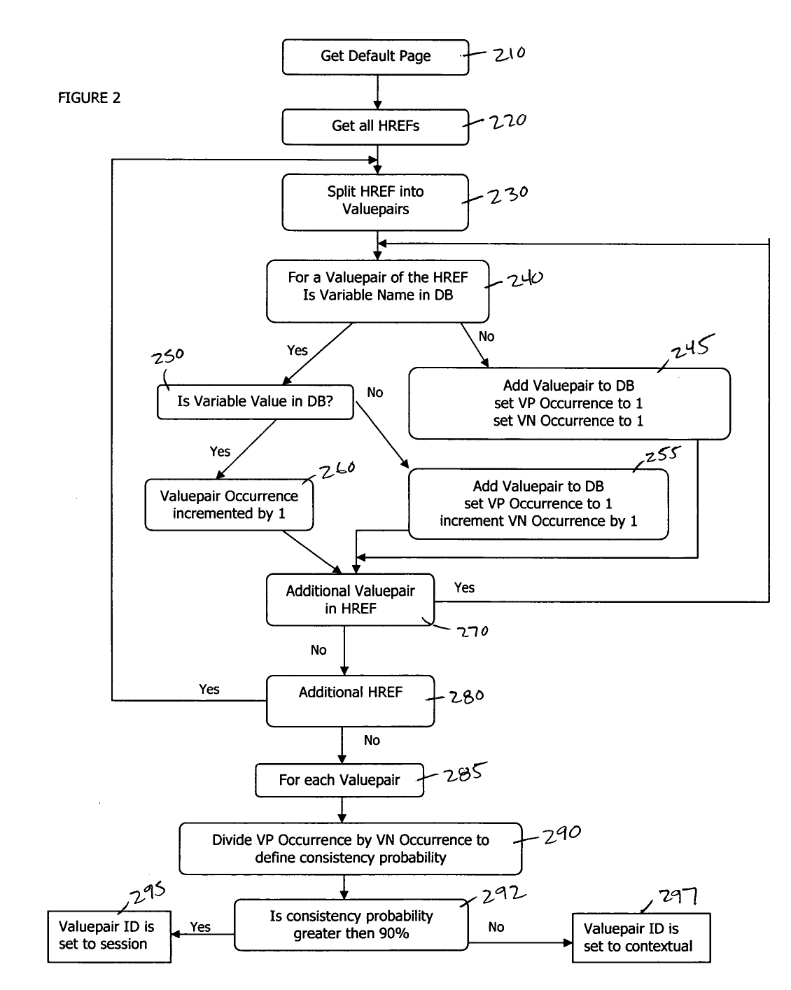

FIG. 2 generally represents an application context in which the invention may be utilized. If the search engine has not indexed the target web site in the current crawl, the invention will perform an initial analysis of the root document (or default page) of the web site, Step 210. All of the hyperlink references on the page are retrieved, Step 220. For example, a hyperlink reference may be:
http://www.dipsie.com/bot/default.aspx?v1=10&v2=20&v3=30.

For each hyperlink reference the method extracts the variables and splits the variables into value pairs, Step 230. Value pairs are defined as variable name and variable value definitions for each x=y relationship contained in a hyperlink reference. In the above reference, the method would break the reference variables into 3 value pairs. Those being: variable 1 name=v1, variable 1 value=10; variable 2 name=v2, variable 2 value=20; and variable 3 name=v3, variable 3 value=30. For each value pair found in the HREF, the variable name is check to determined if the same is stored in the database, Step 240. If the variable name is not in the database, the value pair is added to the database, a VP occurrence marker is set to one and a VN occurrence marker is set to one, Step 245. If the variable name is in the database, the variable value is check against the variable value in the database associated with the variable name, Step 250. If the variable value is not in the database, the value pair is added to the database, a VP occurrence marker is set to one and the VN occurrence marker is incremented by one set to one, Step 255. If the variable value is in the database, the VP occurrence marker defined for the value pair is incremented by 1, Step 260. The method repeats until all value pairs in the hyperlink reference have been checked, Step 270, and all hyperlink references have been checked, Step 280.

The method continues by determining whether each value pair is a session variable or a contextual variable, Step 285. For each value pair the VP Occurrence marker is divided by the VN Occurrence marker, Step 290. If this value is greater than 90%, Step 292, we consider the value pair to be a session variable, Step 295, otherwise it is a contextual variable, Step 297.

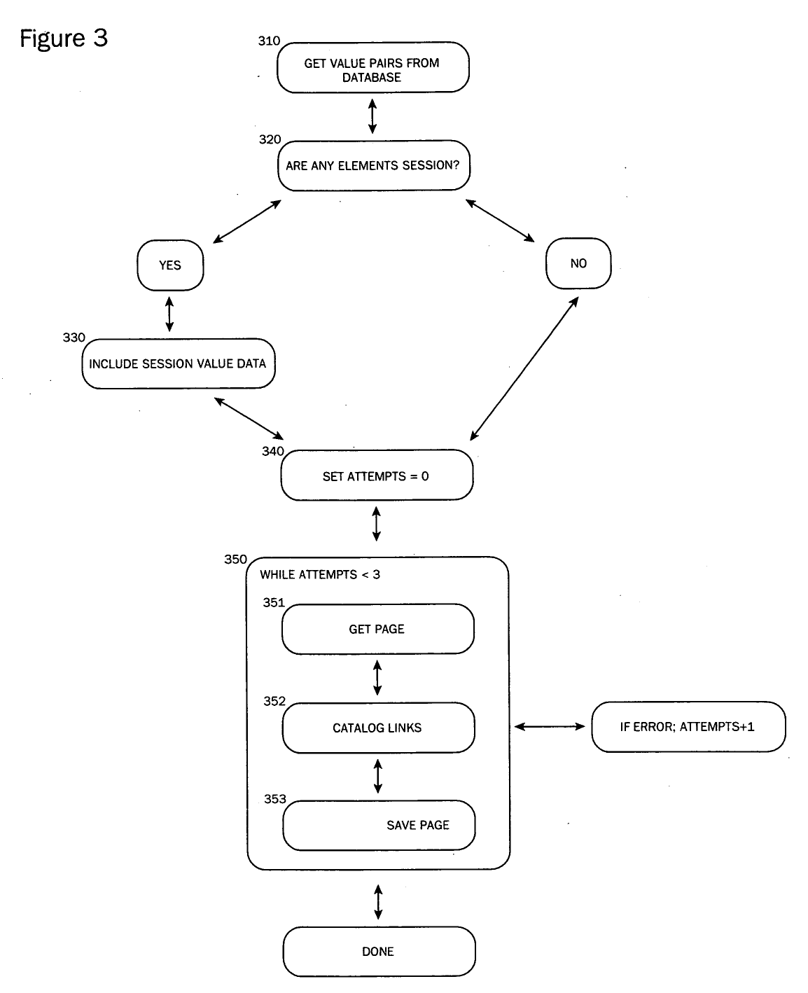

FIG. 3 generally represents the continuation (from FIG. 2) of the application context in which the invention may be utilized. Once the value pairs structure has been mapped and saved to the database, the invention begins the crawl process on the target web site. First, the invention pulls the stored information about the target site's URL structure from the database, Step 310. If any value pairs for the page are session variables, Step 320, the method includes the necessary session information in the appropriate value pairs, Step 330, along with the contextual value pairs retrieved from the database. One the URL has been generated, the invention begins the retrieval process from the target web site, Step 340. The method will then try to retrieve the web page from the target web site, Step 350. It retrieves the page, Step 351, analyzes and catalogs links on the page, Step 352, saves the retrieved page, Step 353, and updates the database. If the method cannot retrieve the page, the attempt is retried. While the preferred embodiment is to have three attempts, this may change without affecting the scope of the invention. After three tries, the invention will update the page reference in the database with an error code stating the page cannot be retrieved.

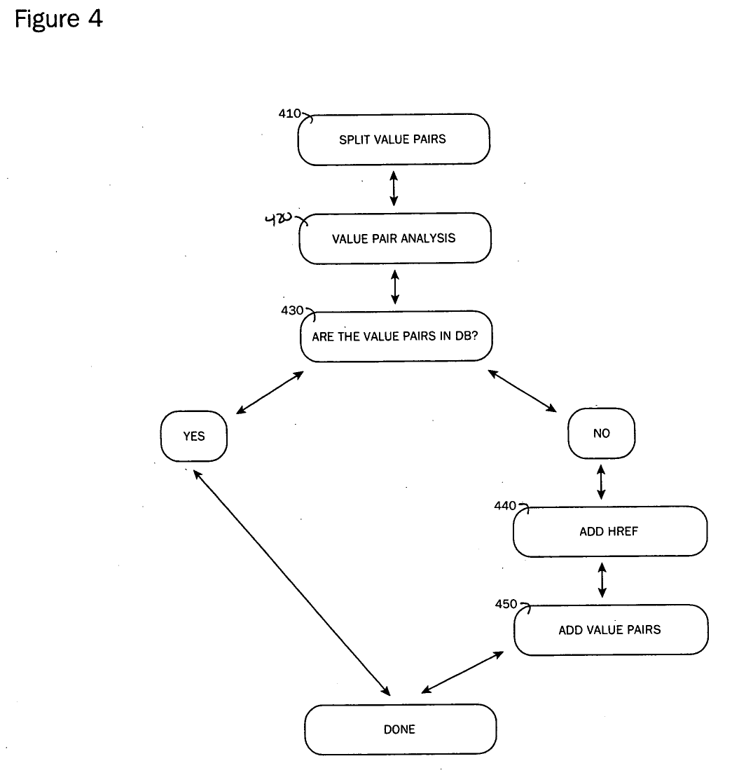

FIG. 4 generally represents the analyzing and cataloging process within the application context in which the method may be utilized. For each hyperlink identified on the retrieved page, the invention will then split the link's value pairs, Step 410, perform a value pair analysis, Step 420, and check to verify that the link is not in the database yet before adding it, Step 430. For each variable in the value pair set, it will check the values against the master session values identified in the initial catalog process. Those variables that match session variables are tagged accordingly with the remainder being tagged as contextual value pairs. The URL value pairs, Step 440, and hyperlinks, Step 450, are then saved to the database.

From the foregoing and as mentioned above, it will be observed that numerous variations and modifications may be effected without departing from the spirit and scope of the novel concept of the invention. It is to be understood that no limitation with respect to the specific embodiments illustrated herein is intended or should be inferred. It is, of course, intended to cover by the appended claims all such modifications as fall within the scope of the claims.

1. A computer implemented method for performing a crawl of a web-page on a server, the web-page containing a URL with a variable, the method comprising:
retrieving the URL with said variable;
extracting the variable from said URL;
retrieving said web page that was previously inaccessible to the crawl, by presenting said URL with said variable to said server to gain access to said web page.

2. The computer implemented method of claim 1 further comprising reposing said web page on a database.

3. The computer implemented method of claim 1 wherein said variable is split into a variable value and a variable name the method further comprising comparing said variable name against previously cataloged variable names reposed on a database and when said variable name is substantially equal to a cataloged variable name, comparing said variable value against a cataloged variable value corresponding to said cataloged variable name such that defining said variable name as a session variable when said variable value is above a predetermined probability threshold of said cataloged variable value.

4. The computer implemented method of claim 3 wherein the step of retrieving said web page that was previously inaccessible to the crawl further includes presenting the session variable to the server.

5. The computer implemented method of claim 3 further comprising defining said variable name as a contextual variable when said variable value is below a predetermined probability threshold of said cataloged variable value.

6. The computer implemented method of claim 3 wherein when said variable name is not previously cataloged in said database retrieving said URL with said variable, defined as a second variable, and comparing said variable against said second variable wherein when said variable value is above a predetermined probability threshold of a second variable value, defined by said second variable, said variable is a session variable and when said variable value is below said predetermined probability threshold of said second variable value, said variable is a contextual value.

7. A computer-executable crawler application stored on a computer readable storage medium that is accessible to a server computer coupled to a network that is accessible to a web page that has a URL with a variable, the application comprising:
executable code for retrieving the URL with said variable;
executable code for extracting the variable from said URL;
executable code for retrieving said web page that was previously inaccessible to the crawl, by presenting said URL with said variable to said server to gain access to said web page.
